(19) United States
(12) Patent Application Publication
(10) Pub. No.: US 2025/0167900 A1
(43) Pub. Date: May 22, 2025

(54) SYSTEMS AND METHODS FOR MANAGING DISTRIBUTED SCANNING

(71) Applicant: Meta Platforms Technologies, LLC, Menlo Park, CA (US)

(72) Inventor: Siddharth Ray, Sunnyvale, CA (US)

(73) Assignee: Meta Platforms Technologies, LLC, Menlo Park, CA (US)

(21) Appl. No.: 18/916,082

(22) Filed: Oct. 15, 2024

Related U.S. Application Data
(60) Provisional application No. 63/601,549, filed on Nov. 21, 2023.

(51) Int. Cl. H04B 17/318; H04B 17/20

(52) U.S. Cl. CPC H04B 17/318; H04B 17/255

(57) ABSTRACT

Systems and methods for distributed scanning may include a first device, of a device set including a plurality of devices, which receives a request for determining a location of the device set, according to a frequency scan across a frequency range. The first device may determine, according to one or more metrics, a state of each of the plurality of devices of the device set. The first device may distribute respective portions of the frequency range for scanning to the plurality of devices, according to the state of each device. The first device may determine the location of the device set, according to scan data received from the plurality of devices responsive to scanning the respective portions of the frequency range.

### CROSS-REFERENCE TO RELATED APPLICATIONS

This application claims the benefit of and priority to U.S. Provisional Application No. 63/601,549, filed Nov. 21, 2023, the contents of which are incorporated herein by reference in their entirety.

### FIELD OF DISCLOSURE

The present disclosure is generally related to wireless communication between devices, including but not limited to, systems and methods for managing distributed scanning.

### BACKGROUND

Augmented reality (AR), virtual reality (VR), and mixed reality (MR) are becoming more prevalent, which such technology being supported across a wider variety of platforms and device. Some AR/VR/MR devices may include multiple devices which communicate with one another as part of a single interactive experience.

### SUMMARY

In one aspect, this disclosure relates to a method including: receiving, by a first device of a device set including a plurality of devices, a request for determining a location of the device set, according to a frequency scan across a frequency range; determining, by the first device, according to one or more metrics, a state of each of the plurality of devices of the device set; distributing, by the first device, respective portions of the frequency range for scanning to the plurality of devices, according to the state of each device; and determining, by the first device, the location of the device set, according to scan data received from the plurality of devices responsive to scanning the respective portions of the frequency range.

In some embodiments, the state includes at least one of a battery state, a thermal state, or an available resource state. In some embodiments, the method includes determining, by the first device, the state of a second device of the device set satisfies a threshold criterion; and distributing, by the first device, the scans to each of the devices of the device set, other than the second device, responsive to the state of the second device satisfying the threshold criterion. In some embodiments, the method includes determining, by the first device, the state of each device of the device set satisfies a threshold criterion; and distributing, by the first device, the scans across each of the devices of the device set, according to the state of each device satisfying the threshold criterion. In some embodiments, each device of the device set include a device which is held or worn by a single user, together with other devices of the device set.

In some embodiments, receiving the request includes receiving, by a scan manager of the first device, from a location manager of the first device, the request for determining the location of the device set, wherein the location manager sends the request to the scan manager responsive to receiving a corresponding request from an application of the first device. In some embodiments, the method includes receiving, by the scan manager of the first device, the scan data from each of the plurality of devices of the device set; transmitting, by the scan manager, to the location manager, compiled scan data based on the scan data received from the plurality of devices; and transmitting, by the location manager to the application, the location of the device set determined according to the compiled scan data. In some embodiments, the scan data includes an identifier of a remote device identified on a channel within the portion of the frequency spectrum and a signal strength of one or more signals detected from the remote device. In some embodiments, determining the location of the device set includes: transmitting, by the first device, to a server, compiled scan data including the identifiers of remote devices identified on the frequency spectrum and the corresponding signal strength of signals; and receiving, by the first device, from the server, the location determined by the server according to the identifiers and the corresponding signal strength of the signals.

In some embodiments, the method includes receiving, by the first device, from each of the plurality of devices of the device set, the one or more metrics relating to the respective device, wherein the one or more metrics include at least one of: device capability information, scan duration, scan power, battery level, thermal level, or connection status information. In some embodiments, the method includes receiving, by the first device, from the plurality of devices of the device set, the scan data, where the scan data from a respective device of the plurality of devices is either obtained by the respective device in responsive to the first device triggering scanning the corresponding portion of the frequency range, or is obtained by the respective device from cache in response to a previous scan of the corresponding portion of the frequency range.

In another aspect, this disclosure is directed to a first device including a wireless transceiver and one or more processors configured to: receive a request for determining a location of a device set, according to a frequency scan across a frequency range, the device set including a plurality of devices including the first device; determine, according to one or more metrics, a state of each of the plurality of devices of the device set; distribute, respective portions of the frequency range for scanning to the plurality of devices, according to the state of each device; and determine the location of the device set, according to scan data received from the plurality of devices responsive to scanning the respective portions of the frequency range.

In some embodiments, the portions of the frequency range are distributed such that the scan data from the devices of the device set are received by the first device at substantially the same time. In some embodiments, each device of the device set include a device which is held or worn by a single user, together with other devices of the device set. In some embodiments, the request includes a first request, and the one or more processors are configured to: execute a scan manager and a location manager. The location manager may be configured to: receive a second request from an application of the first device, the second request corresponding to the first request; and transmit the first request to the scan manager responsive to the second request. The scan manager may be configured to: receive the scan data from each of the plurality of devices of the device set; transmit, to the location manager, compiled scan data based on the scan data received from the plurality of devices. In some embodiments, the location manager is further configured to transmit the location of the device set to the application, where the location is determined according to the compiled scan data. In some embodiments, the scan data includes an identifier of a remote device identified on a channel within the portion of the frequency spectrum and a signal strength of one or more signals detected from the remote device.

In some embodiments, to determine the location of the device set, the one or more processors are configured to: transmit, to a server, compiled scan data including the identifiers of remote devices identified on the frequency spectrum and the corresponding signal strength of signals; and receive, from the server, the location determined by the server according to the identifiers and the corresponding signal strength of the signals. In some embodiments, the one or more metrics comprise at least one of device capability information, scan duration, scan power, battery level, thermal level, or connection status information.

In yet another aspect, this disclosure is directed to a non-transitory computer readable medium storing instructions that, when executed by one or more processors, cause the one or more processors to receive a request for determining a location of a device set, according to a frequency scan across a frequency range, the device set comprising a plurality of devices. The instructions may further cause the one or more processors to determine, according to one or more metrics, a state of each of the plurality of devices of the device set. The instructions may further cause the one or more processors to distribute, respective portions of the frequency range for scanning to the plurality of devices, according to the state of each device. The instructions may further cause the one or more processors to determine the location of the device set, according to scan data received from the plurality of devices responsive to scanning the respective portions of the frequency range.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for distributed scanning, according to an example implementation of the present disclosure.

FIG. 6 is a block diagram of an environment in which distributed scanning may be performed, according to an example implementation of the present disclosure.

FIG. 7 is a flowchart showing an example method of distributed scanning, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

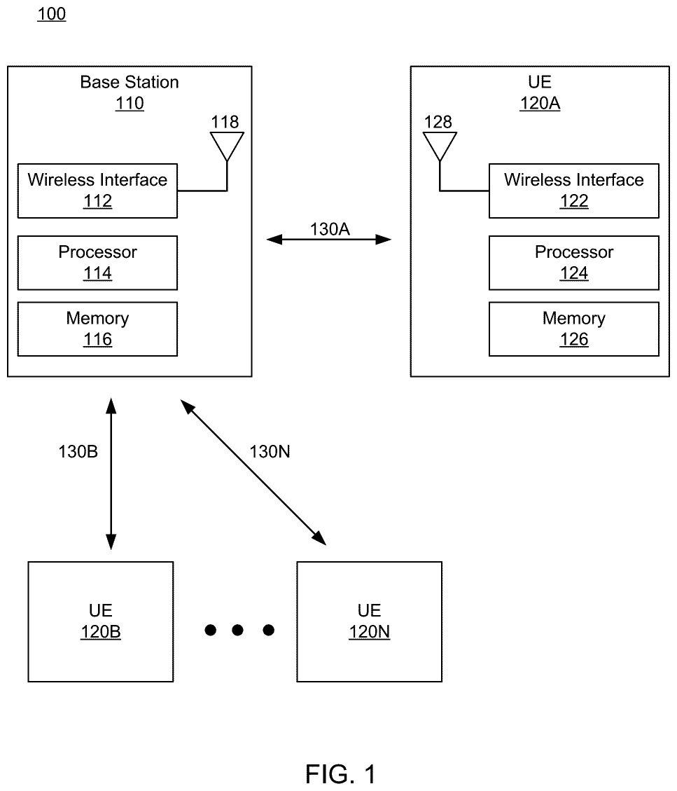

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHZ). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHZ). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

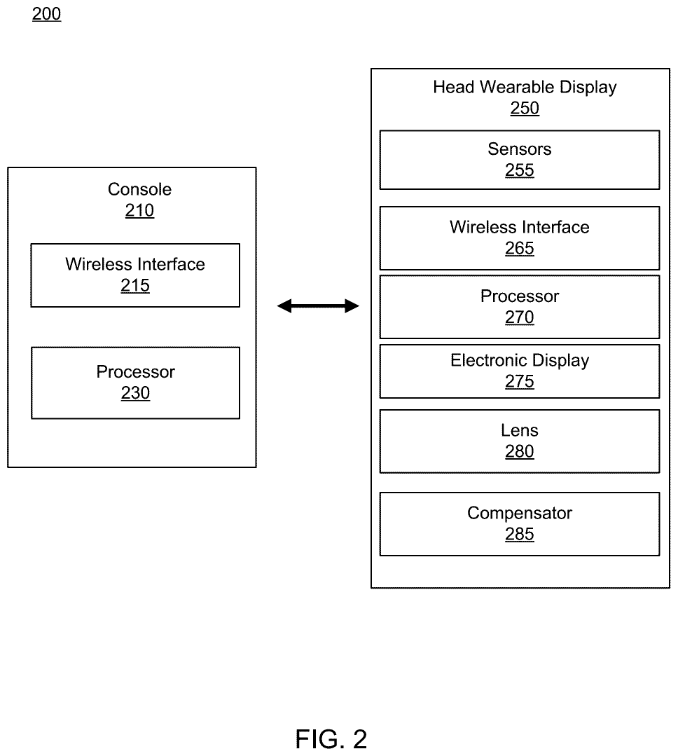

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space.

The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

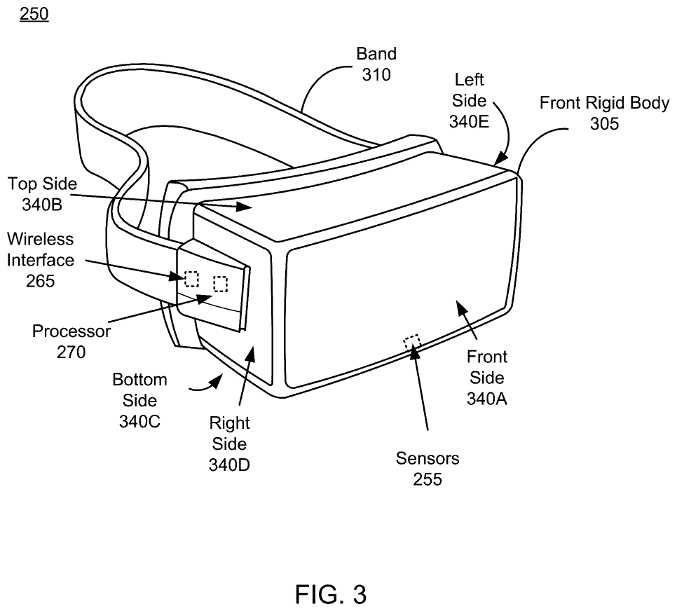

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

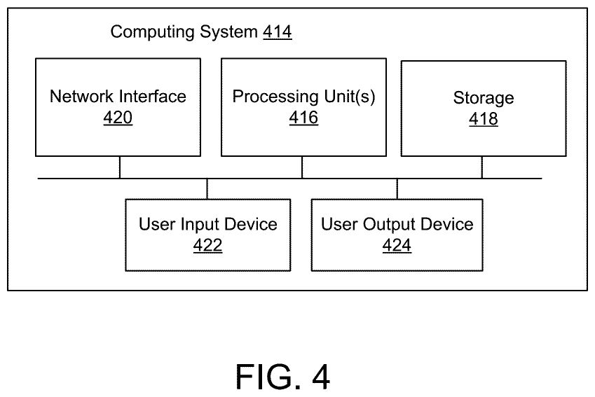

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

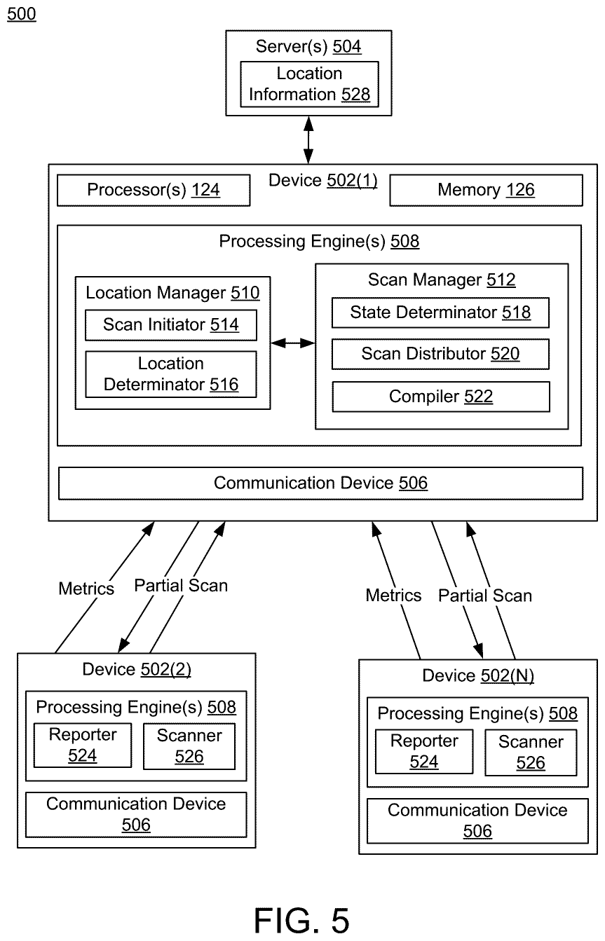

Referring now to FIG. 5-FIG. 7, this disclosure is directed to systems and methods for managing distributed scanning across devices of a device set. Wireless positioning between devices may be used for localization, e.g., in various environments. In some embodiments, such devices may use a wireless local area network (WLAN), such as Wi-Fi, for performing such scanning for determining location of the wireless devices. A WLAN (such as Wi-Fi) scan performed by a device may take approximately two seconds to complete (e.g., in 2.4G/5G settings), which could increase as WLAN implementations shift to 6G. This increase in duration could result in an increase in latency and battery drain, which can make it challenging to satisfy latency and product document of understanding (DoU) requirements (or other compatibility/interoperability requirements). While described as performing scans using WLAN communication technologies, it is noted that the present disclosure may implement or use other wireless communication technologies (or combinations of wireless communication technologies) to perform scans of various frequency bands/ranges/channels, including wireless personal area network (WPAN) technologies (e.g., ultra-wideband, BLUETOOTH, etc.), cellular technologies (e.g., 3G, 4G, LTE, 5G, 6G, etc. cellular technologies and antennas), and so forth.

According to the systems and methods described herein, a system may include a device set including a plurality of devices. The device set may be, for example, a constellation of devices. The constellation of devices may be designed, configured, or otherwise provided as a group which are to be worn or otherwise used together. For example, the device set (or constellation of devices) may include a mobile phone, and any number of wearable devices (e.g., a smartwatch, wrist device, etc., smart glasses or head wearable device, and so forth). In this regard, the device set may be designed to be used together (e.g., in parallel) by a single user, as part of providing a single, cohesive user experience (e.g., an AR/VR/MR experience).

The system may be configured to distribute scan requests across the device set, so that all radio devices (e.g., transceivers) of the respective devices are used in parallel (e.g., simultaneous/parallel scanning). In this regard, the battery impact may be distributed across the device set, rather than being impacted by a single device. In some embodiments, as part of distributing the scan requests, a scan manager can consider current battery levels of the respective devices can be considered as to whether or not to distribute a scan to the respective device (e.g., if one device of the device set has a battery level which is below a threshold, the scans can be distributed to other devices). Once the scans are complete, the scan manager can collect data corresponding to each of the scans, and report the scan data back to a location manager for location determination.

Referring now to FIG. 5, depicted is a block diagram of a system 500 for distributed scanning, according to an example implementation of the present disclosure. As shown in FIG. 5, the system 500 may include a plurality of devices 502(1)-502(N) (generally referred to as device 502, or devices 502), and one or more server(s) 504. The devices 502 may be, include, or form a device set (or a constellation of devices 502). Each of the devices 502 of the device set may be configured to held or worn by a single user. For example, the devices 502 may include wearable and/or handheld devices 502, such as smart glasses or head wearable devices, smart watches, smartphone, console device, and so forth. In other words, the devices 502 may be or include devices similar to those described above with reference to FIG. 1-FIG. 4.

In some embodiments, the first device 502(1) may be a control device, and the other devices 502(2)-502(N) may be peripheral devices. For example, the control device may be a smartphone, whereas the peripheral devices may be wearable devices (such as smart glasses or a head wearable device, a smart watch, etc.). While this embodiment is shown and described, it is noted that any of the devices 502 may be the control device, and other devices of the device set may be peripheral devices.

The devices 502 may include one or more processors 124 and memory 126, which may be similar to the processor(s) 124 and memory 126 described above. The devices 502 may also include a respective communication device 506, which may include a wireless interface 122 and antenna 128 similar to those described above with reference to FIG. 1. The communication device 506 may be configured to support communication via one or more wireless communication protocols or technologies, such as (but not limited to) wireless local area network (WLAN) technology (e.g., WI-FI), wireless personal area network (WPAN) technology (e.g., BLUETOOTH and/or ultra-wideband technology)), and/or cellular technology (e.g., 3G, 4G, LTE, 5G, 6G, etc. cellular technologies).

The devices 502 may include one or more processing engines 508. The processing engine(s) 508 may be or include any device, component, element, or hardware designed or configured to perform dedicated functions of the device 502. In some embodiments, the processing engine(s) 508 may include processor(s) 124 (e.g., dedicated cores of a processor or dedicated processors) configured by machine-readable instructions stored on memory 126 to perform the corresponding functions of the device. While particular processing engine(s) 508 are shown on the respective devices 502, it should be understood that the present disclosure is not limited to the particular processing engine(s) 502 shown in FIG. 5. In various embodiments, additional and/or alternative processing engine(s) 502 may be deployed and/or supported by the devices 502. Further, and in some embodiments, a processing engine 508 may be divided into multiple processing engines 508, and/or two or more processing engines 508 may be combined and deployed as a single processing engine 508.

The first device 502 may include a location manager 510 and a scan manager 512. As described in greater detail below, the location manager 510 may be configured to receive a signal to trigger determination of a location of the device 502 (and/or the device set). The location manager 510 may be configured to transmit a request to the scan manager 512 responsive to the signal. The scan manager 512 may be configured to receive the request (e.g., to determine the location of the device/device set), according to a frequency scan across a frequency range. The scan manager 512 may be configured to determine a state of each of the devices 502 (e.g., of the device set) according to one or more metrics. The scan manager 512 may be configured to distribute respective portions of the frequency range for scanning to the devices 502, according to the determined state of the respective devices 502. When the scan manager 512 receives results of the scans (e.g., scan data) from the respective devices 502, the scan manager 512 may be configured to compile the scan results, and report the scan results to the location manager 510. The location manager 510 may be configured to determine the location of the device set, according to the scan data. In some embodiments, the location manager 510 may be configured to determine the location of the device set based on information stored at or otherwise accessible by the server 504.

The location manager 510 may include a scan initiator 514. The scan initiator 514 may be configured to trigger, cause initiation of, or otherwise request a frequency scan of an environment (e.g., of a frequency range to detect signals on various channels of the frequency range by other device(s) in the environment). The frequency range may be or include frequency ranges that may be occupied by other devices communicating via WLAN communication technologies. For example, the frequency range may include a plurality of channels which may be occupied by neighboring WLAN communication devices. The frequency range may include frequencies or channels between 5.725 gigahertz (GHz) and 5.850 GHz (e.g., UNII-3), frequencies or channels between 5.850 GHz and 5.925 GHZ (e.g., UNII-4), frequencies or channels between 6.425 GHz and 6.525 GHz (e.g., UNII-5), frequencies or channels between 6.525 GHz and 6.675 GHz (e.g., UNII-6), or any other frequency ranges.

In some embodiments, the scan initiator 514 may be configured to request the frequency scan responsive to a signal from another device/component/element/hardware. For example, an application executing on, running on, or otherwise supported by the device 502 may be configured to request a location of the device set. The application may be a locally-executing application or service, a remotely-hosted and accessed application or service, and so forth. The application may be configured to request the location for localization within an AR/VR environment, in connection with geolocation services used by the application, and so forth. The application may send the request for the location to the location manager 510, for receipt by the scan initiator 514. The scan initiator 514 may be configured to transmit a request to perform the frequency scan across the frequency range to the scan manager 512, responsive to receiving the signal from the application.

The scan manager 512 may include a state determinator 518. The state determinator 518 may be designed or configured to detect, identify, or otherwise determine a status, condition, or state of each of the devices 502. The state determinator 518 may be configured to determine the state of each device 502, according to one or more metrics received from the devices 502. For example, the devices 502 may each include a reporter 524 which is configured to transmit, communicate, or otherwise provide metric(s) of the device 502 to the state determinator 518. The reporter 524 may be configured to provide the metric(s) of the device 502 on demand from the state determinator 518 (e.g., responsive to a request received by the reporter 524 from the state determinator 518), periodically (e.g., every X milliseconds (ms), every X seconds, every X minutes, and so forth).

The metrics may include, for example, device capability information, scan duration, scan power, battery level, thermal level, and/or connection status information. Device capability information may include, for instance, the types of wireless communication technologies supported, data rates, frequency bands, and security protocols. Scan duration may include the time required to scan a channel or sub-channel of the frequency range. Scan power may include the minimum signal strength detectable by the device as well as the power consumed during a scan. Battery level may include the current charge level, voltage level, and/or the rate of change of the charge/voltage levels. Thermal level may include the device temperature (e.g., external temperature, battery temperature), rate of change of device temperature, and so forth. Connection status information may include whether the device is connected to the first device, the type of connection (e.g., WLAN, WPAN, etc.), and the strength of the connection.

The state determinator 518 may be configured to determine, identify, or otherwise select one or more state(s) for each of the devices 502 (e.g., the first device 502 and the peripheral devices 502) according to the metric(s) received from each of the devices. The states may be or include a battery state, a thermal state, and/or an available resource state. The battery state may be associated with the battery level metric(s) received from each of the reporter(s) 524. Similarly, the thermal state may be associated with the thermal level metric(s) received from each of the reporter(s) 524. The available resource state may be associated with the device capability information, scan duration, scan power, and/or connection status metric(s) received from the reporter(s) 524.

The scan manager 512 may include a scan distributor 520. The scan distributor 520 may be configured to assign, divide, or partition, or otherwise distribute portions of the frequency range to be scanned, to each of the devices 502 for scanning thereby. The scan distributor 520 may be configured to distribute portions of the frequency range to respective devices 502, according to the state of the device 502. In some embodiments, the scan distributor 520 may be configured to compare the state(s) of the device to one or more threshold criterion, for distributing portions of the frequency range to the devices 502. Various examples of results of comparisons for specific devices 502, and corresponding distributions of portions of the frequency spectrum, are described in greater detail below. However, it should be understood that various combinations and permutations of these examples can be used or applied by the scan distributor 520, to apportion and distribute the frequency spectrum for scanning.

In some embodiments, where the state of the device is a battery state, the scan distributor 520 may be configured compare the battery state to a threshold. For example, the scan distributor 520 may be configured to compare the battery state to a threshold battery level, a threshold discharge rate, etc. The scan distributor 520 may be configured to distribute or apportion lesser portions of the frequency spectrum to devices 502, based on the comparison. For example, where the battery state is less than a threshold battery level, or is discharging at a discharge rate greater than the threshold discharge rate, the scan distributor 520 may be configured to distribute less of the frequency spectrum to that device 502, as compared to other devices 502. Additionally, and in some implementations, where the battery state for a device 502 is less than the threshold battery level (e.g., less than 15% charge), the scan distributor 520 may be configured to distribute portions of the frequency spectrum to other devices 502, and forego distributing any portions of the frequency spectrum to the device 502 whose battery state is less than the threshold battery level.

In some embodiments, where the state of the device is a thermal state, the scan distributor 520 may be configured compare the thermal state to a threshold. Similar to the battery state, the scan distributor 520 may be configured to compare the thermal state to a threshold temperature, a rate of change of temperature, and so forth. The scan distributor 520 may be configured to distribute or apportion lesser portions of the frequency spectrum to devices 502, based on the comparison. For example, where the thermal state is greater than a threshold temperature (or the temperature is increasing at a rate of change greater than the threshold rate of change), the scan distributor 520 may be configured to distribute less of the frequency spectrum to that device 502, as compared to other devices 502. Additionally, and in some implementations, where the temperature state for a device 502 is outside of a threshold temperature range (e.g., greater than an upper limit and/or less than a lower limit), the scan distributor 520 may be configured to distribute portions of the frequency spectrum to other devices 502, and forego distributing any portions of the frequency spectrum to the device 502 whose temperature state is outside of the threshold temperature range.

In some embodiments, the scan distributor 520 may be configured to distribute portions of the frequency range according to the device capability information, scan duration, scan power, and/or connection status information. For example, where the device capability information indicates certain frequency ranges are scannable by one device, and not scannable by other devices, the scan distributor 520 may be configured to distribute portions of the frequency range according to which frequency ranges are scannable by the respective devices 502. Such implementations may optimize frequency scanning according to ability of the respective devices to scan particular frequency ranges. As another example, where one device 502 has a scanning duration which is less than another device 502, the scan distributor 520 may be configured to provide a greater portion of the frequency range to the device 502 having a lesser scan duration. Such implementations may optimize frequency scanning to provide scan results at substantially the same time across the device set. As yet another example, where one device 502 has a greater scan power than other device 502, the scan distributor 520 may be configured to provide particular portions of the frequency range which are more likely to be occupied to the device having a greater scan power (since that increases the likelihood of successful detection). As still another example, where the connection status information indicates a weak signal strength of the connection between the first device 502 and a peripheral device 502 which will be providing scan results, the scan distributor 520 may be configured to forego distributing a portion of the frequency range to the peripheral device (so as to avoid a likelihood of results not being successfully received by the first device 502). Additionally, where the connection status information indicates a peripheral device 502 is currently using a connection, the scan distributor 520 may be configured to forego distributing a portion of the frequency range to the peripheral device because the communication device 506 of the peripheral device is already occupied.

Responsive to partitioning, apportioning, or otherwise segmenting the frequency range into partial scans, the scan distributor 520 may be configured to communicate, transmit, send, or otherwise provide a signal to each of the devices 502 (e.g., including or excluding the first device 502(1)), to initiate the frequency scan of the respective portions of the frequency range. The signal may indicate particular channels for the respective devices to scan, the particular portions of the frequency range to scan, etc.

The devices 502 may each include a respective scanner 526. The scanner 526 may be configured to cause the communication device 506 to switch to, hop to, or otherwise listen on particular channels for any signals received from neighboring devices. The scanner 526 may be configured to listen on channels according to the portion of the frequency range assigned to the respective device 502 by the scan distributor 520. The scanner 526 may be configured to detect, identify, or otherwise determine whether any signals are received on the channel. In some embodiments, the scanner 526 may be configured to reside on the channel for the scan duration, to determine whether any signals are received/detected during the scan duration. The signals may include, for example (e.g., in a header), an identifier associated with the transmitting device. Where the scanner 526 identifies a signal, the scanner 526 may be configured to store the identifier (e.g., the device identifier, such as an access point (AP) ID) along with a signal strength of the signal (e.g., a received signal strength indicator (RSSI)). In some embodiments, the scanner 526 may be configured to store the identifier and signal strength in cache for reporting (e.g., via the reporter 524) to the scan manager 512 on demand. In some embodiments, the scanner 526 may be configured to store the identifier and signal strength in a buffer following scanning one channel, while the scanner 526 scans other channels of the portion of the frequency spectrum.

The reporter 524 may be configured to compile scan results for each of the channels scanned by the scanner 526. In some embodiments, the compiled scan results may include a channel number of the channel scanned, along with the identifier and signal strength corresponding to the signal(s) identified by the scanner 526. The reporter 524 may be configured to transmit, communicate, send, or otherwise provide scan data (e.g., the compiled scan results) back to the scan manager 512. The reporter 524 may be configured to provide the scan data to the scan manager 512 responsive to the request from the scan distributor 520. As noted above, in some embodiments, the reporter 524 may be configured to pull the scan data from the cache as the compiled scan results. In this regard, the reporter 524 may be configured to provide scan data from a most recent scan of the portion of the frequency range (e.g., stored in the cache), in response to a request for a partial scan. In some embodiments, where the scanner 526 performs the scan in response to the request, the reporter 524 may be configured to pull the scan data from a buffer. For example, the scanner 526 may be configured to buff the scan results for each channel in the buffer until the scanner 526 completes the scans of each channel in the portion of the frequency range allocated to the respective device. The reporter 524 may be configured to retrieve or otherwise receive the scan results from the buffer, and provide the scan data compiled for each of the channels to the scan manager 512.

The scan manager 512 may include a compiler 522. The compiler 522 may be designed or configured to group together, combine, or otherwise compile scan results from each of the devices 502 which performed a partial scan. Similar to the reporter 524 compiling scan results for channels of a portion of the frequency range, the compiler 522 may be configured to compile the scan results for each portion of the frequency range, such that the compiled scan results 522 is for the full frequency range. The compiler 522 may be configured to compile the scan results across the frequency range, to generate compiled scan results from each partial scan. In this regard, the compiled scan results may include scan results from each (or a subset) of peripheral devices 502(2)-502(N) and/or the first device 502(1), according to the portions of the frequency range distributed by the scan distributor 520. The compiler 522 may be configured to communicate, send, share, or otherwise provide the compiled scan results to the location manager 510.

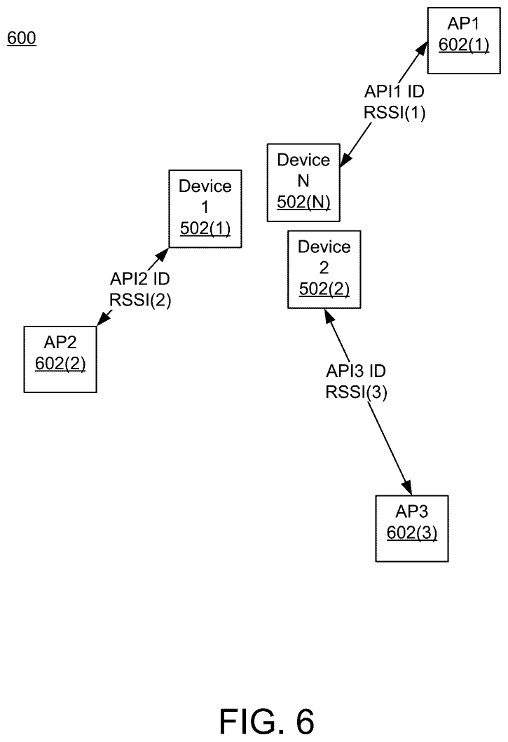

The location manager 510 may include a location determinator 516. The location determinator 516 may be designed or configured to detect, identify, or otherwise determine the location of the device set according to the scan results. In some embodiments, the location manager 510 may be configured to determine the location of the device set according to the identified neighboring devices and the respective signal strength identified responsive to the scans. An example of the determination of the location is described below with reference to FIG. 6.

Referring now to FIG. 6, with continued reference to FIG. 5, depicted is a block diagram of an environment 600 in which distributed scanning may be performed, according to an example implementation of the present disclosure. As shown in FIG. 6, the environment 600 may include the device set (e.g., devices 502(1)-(N)) and various neighboring devices 602. In some embodiments, the neighboring devices 602 may be or include access points 602(1)-(3) (generally referred to as an access point 602). Each access point 602 may occupy a particular channel of the frequency range. For example, the access point 602 may occupy a respective 20 MHz channel of the frequency range, for communication with various devices of a service set (SS). As described above, the devices 502 of the device set may be configured to perform respective partial frequency scan of the frequency range, to identify those neighboring devices 602 occupying specific channels of the frequency range. As shown in FIG. 6, and as one example, the first device 502(1) may scan a channel in which the second access point AP(2) 602(2) occupies, the second device 502(2) may scan a channel in which the third access point AP(3) 602(3) occupies, and the n-th device 502(N) may scan a channel in which the first access point AP(1) 602(1) occupies. Each of the devices 502, as part of the scan, may identify the corresponding identifier and signal strength of signals received from the respective neighboring device 602 (e.g., an AP ID and RSSI). As such, given that the devices of the device set are in relatively close proximity to one another (e.g., because they are worn/held/operated by the same/a single user), the signal strength of signals received from neighboring devices may be indicative of a relative location of the device set from the neighboring devices.

Referring back to FIG. 5, the location determinator 516 may be configured to determine the location of the device set according to the compiled scan information. In some embodiments, the location determinator 516 may be configured to determine the location of the device set using information from the server(s) 504. For example, the server(s) 504 may be configured to store, maintain, or otherwise include location information 528 of known device locations. The location determinator 516 may be configured to report, transmit, communicate, or otherwise provide the identifiers of the neighboring devices 602 identified as part of the scan of the frequency range to the server(s) 504. The server(s) 504 may be configured to provide the known location of the neighboring devices associated with the identifiers back to the location determinator 516. The location determinator 516 may be configured to determine the location of the device set based on the known location of the neighboring devices. For example, the location determinator 516 may be configured to determine the location of the device set using the signal strength and the known locations of the neighboring devices. The location determinator 516 may be configured to compute the location of the device set by executing a triangulation function using the signal strength and known locations of the neighboring devices.

While this embodiment is described, it is noted that various implementations and permutations of this determination may be implemented. For example, and in some embodiments, the location determinator 516 may be configured to transmit the signal strength with the identifiers to the server(s) 504. In this example, the servers 504 may be configured to determine the location of the device set by first determining the known locations of the neighboring devices and executing the triangulation function using the signal strength to determine the location of the device set. Additionally or alternatively, and in some embodiments, in addition to the signal strength and the identifier, the neighboring devices may be configured to broadcast, signal, or otherwise identify their respective location (e.g., global or geolocation). In this example, the location determinator 516 may be configured to determine the location of the device set using the signal strength, without retrieving information from the server(s) 504.

The location determinator 516 may be configured to transmit, communicate, send, or otherwise provide the location of the device set to the component/element/hardware which caused the scan initiator 514 to perform the scan. For example, where an application of the device 502(1) requests a location of the device set, the location determinator 516 may be configured to transmit the location of the device set to the application for use thereby.

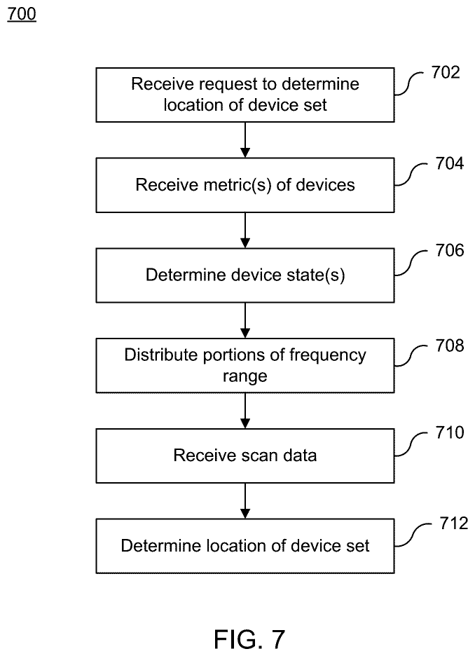

Referring now to FIG. 7, depicted is a flowchart showing an example method 700 of distributed scanning, according to an example implementation of the present disclosure. The method 700 may be performed or otherwise executed by the devices, elements, components, or hardware described above with reference to FIG. 1-FIG. 6. While described with reference to the first device 502(1), it is noted that any of the devices 502 may perform the method 700. As a brief overview, at step 702, a first device may receive a request to determine a location of a device set. At step 704, the first device may receive metrics of the devices. At step 706, the first device may determine device states. At step 708, the first device may distribute portions of a frequency range. At step 710, the first device may receive scan data. At step 712, the first device may determine the location of the device set.

At step 702, a first device may receive a request to determine a location of a device set. In some embodiments, the first device may receive the request to determine the location of the device set, according to a frequency scan across a frequency range. In some embodiments, the first device may receive the request from an application which is executing or otherwise supported by the first device (and other device(s) of the device set). The first device may receive the request from a remote application and/or a locally executing application. The first device may receive the request, to cause the first device to initiate a scan of a frequency range. In some embodiments, a scan manager of the first device may receive the request for determining the location of the device set from a location manager, in response to the location manager receiving a corresponding request from the application. In other words, the application may transmit a request to the location manager, requesting the location manager determine and provide the location of the device set to the application. The location manager may transmit a corresponding request to the scan manager, to cause the scan manager to initiate a scan of a frequency range.

At step 704, the first device may receive metrics of the devices. In some embodiments, the first device may determine and/or receive metrics from each of the devices of the device set. In some embodiments, the first device may receive the metrics in response to a request for the metrics from the devices. In some embodiments, the first device may receive the metrics periodically. The metrics may include, for example, device capability information, scan duration, scan power, battery level, thermal level, or connection status information.

At step 706, the first device may determine device states. In some embodiments, the first device may determine a device state for each of the plurality of devices of the device set. The first device may determine the device state based on or according to the metric(s) received at step 704. In some embodiments, the first device may determine at least one of a battery state, thermal state, and/or an available resource state, based on or according to the metric(s) received from the respective devices. The first device may determine the state(s) prior to distributing any portion of the frequency range for scanning by the respective devices. The first device may determine the device state(s), to determine which portion(s) of the frequency range to distribute to the respective devices.

At step 708, the first device may distribute portions of a frequency range. In some embodiments, the first device may distribute respective portions of the frequency ranges for scanning to the plurality of devices (e.g., of the device set), according to the state of each device. In some embodiments, the first device may forego distributing portions of the frequency range to a given device based on a comparison of a device state for the given device to various threshold criterion. For example, the first device may determine that the state of a second device of the device set satisfies a threshold criterion (e.g., battery state is less than a threshold battery state, thermal state is greater than a threshold thermal state, available resources state is less than a threshold availability). The first device may distribute scans (e.g., respective portions of the frequency range for scanning) to each of the devices of the device set, other than the second device, responsive to the state of the second device satisfying the threshold criterion. In some embodiments, the first device may distribute portions of the frequency range to each of the devices based on the state of each device of the device set satisfying a threshold criterion. For example, where each of the battery/thermal/available resource state satisfy a criteria for scanning, the first device may distribute scans across each of the devices of the device set. In some instances, the first device may distribute scans evenly (or approximately evenly) across each of the devices of the device set. For example, where the number of channels of the frequency range is evenly divisible by the number of devices in the device set, the first device may evenly distribute the channels across the device set. Where the number of channels are not evenly divisible, the first device may evenly distribute the nearest evenly divisible number of channels across the device set, with the remainder of channels distributed to one or more of the devices of the device set.

At step 710, the first device may receive scan data. In some embodiments, the first device may receive the scan data from each of the plurality of devices of the device set. The scan data may include, for example, identifiers of devices (e.g., neighboring devices) identified on channels which are scanned by a respective device, and a signal strength of signals received from the neighboring devices. The first device may receive the scan data responsive to distributing the portion(s) of the frequency range to the devices. For example, the first device may (e.g., following step 708) transmit a signal to each of the devices, indicating the respective portions of the frequency range distributed to the respective devices. In some embodiments, the signal may trigger performance of the scan on the respective portion of the frequency range. For example, responsive to the devices receiving the signal, the devices may perform the scan on the respective portions of the frequency range determined by the first device (and indicated in/by the signal). In some embodiments, the signal may trigger retrieval of scan data from cache, of a most recent scan on the respective portions of the frequency range. For example, the devices may periodically perform scanning of various channels, and store the scan results of such scans in cache. The first device may send a signal indicating the portion(s) of frequency range that a respective device is to provide scan results. The respective device may retrieve the scan results for the portion(s) of the frequency range from cache (e.g., from a previous scan), and transmit the scan results to the first device.

At step 712, the first device may determine the location of the device set. In some embodiments, the first device may determine the location of the device set according to scan data received from the plurality of devices responsive to scanning the respective portions of the frequency range. The first device may determine the location of the device set according to the scan data received at step 710. In some embodiments, the first device may compile the scan data received from each of the devices at step 710 and transmit the compiled scan data to the location manager. The location manager may determine the location of the device set (e.g., according to the compiled scan data) and transmit the location of the device set to the application.

In some embodiments, the first device (e.g., the location manager) may determine the location of the device set based on information from a server. For example, the first device may transmit compiled scan data (e.g., identifiers and signal strength) to the server. The server may determine the location of the device set according to the compiled scan data, and transmit the location to the first device. The server may determine the location of the device set based on known location of neighboring devices (e.g., which match the identifiers from the compiled scan data), and using a triangulation function based on the signal strength relative to the known location of the neighboring devices. In some embodiments, the first device may determine the location of the device set locally. For example, the first device may transmit the identifiers to the server and receive the known location of the corresponding neighboring devices from the server. The first device may determine the location of the device set using a triangulation function, according to the signal strength of signals from the neighboring devices and the known location of such neighboring devices. As another example, the first device may receive (e.g., in addition to the identifiers from the neighboring devices) a geolocation of the neighboring devices. The first device may determine the location of the device set using a triangulation function, according to the signal strength of signals from the neighboring devices and their respective geolocations.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
receiving, by a first device of a device set including a plurality of devices, a request for determining a location of the device set, according to a frequency scan across a frequency range;
determining, by the first device, according to one or more metrics, a state of each of the plurality of devices of the device set;
distributing, by the first device, respective portions of the frequency range for scanning to the plurality of devices, according to the state of each device; and
determining, by the first device, the location of the device set, according to scan data received from the plurality of devices responsive to scanning the respective portions of the frequency range.

2. The method of claim 1, wherein the state comprises at least one of a battery state, a thermal state, or an available resource state.

3. The method of claim 1, further comprising:
determining, by the first device, the state of a second device of the device set satisfies a threshold criterion; and
distributing, by the first device, the respective portions of the frequency range to each of the devices of the device set, other than the second device, responsive to the state of the second device satisfying the threshold criterion.

4. The method of claim 1, further comprising:
determining, by the first device, the state of each device of the device set satisfies a threshold criterion; and
distributing, by the first device, the respective portions of the frequency range across each of the devices of the device set, according to the state of each device satisfying the threshold criterion.

5. The method of claim 1, wherein each device of the device set comprise a device which is held or worn by a single user, together with other devices of the device set.

6. The method of claim 1, wherein receiving the request comprises receiving, by a scan manager of the first device, from a location manager of the first device, the request for determining the location of the device set, wherein the location manager sends the request to the scan manager responsive to receiving a corresponding request from an application of the first device.

7. The method of claim 6, further comprising:
receiving, by the scan manager of the first device, the scan data from each of the plurality of devices of the device set;
transmitting, by the scan manager, to the location manager, compiled scan data based on the scan data received from the plurality of devices; and
transmitting, by the location manager to the application, the location of the device set determined according to the compiled scan data.

8. The method of claim 1, wherein the scan data comprises an identifier of a remote device identified on a channel within the portion of the frequency spectrum and a signal strength of one or more signals detected from the remote device.

9. The method of claim 8, wherein determining the location of the device set comprises:
transmitting, by the first device, to a server, compiled scan data comprising the identifiers of remote devices identified on the frequency spectrum and the corresponding signal strength of signals; and
receiving, by the first device, from the server, the location determined by the server according to the identifiers and the corresponding signal strength of the signals.

10. The method of claim 1, further comprising:
receiving, by the first device, from each of the plurality of devices of the device set, the one or more metrics relating to the respective device, wherein the one or more metrics comprise at least one of:
device capability information, scan duration, scan power, battery level, thermal level, or connection status information.

11. The method of claim 1, further comprising receiving, by the first device, from the plurality of devices of the device set, the scan data, wherein the scan data from a respective device of the plurality of devices is either obtained by the respective device in responsive to the first device triggering scanning the corresponding portion of the frequency range, or is obtained by the respective device from cache in response to a previous scan of the corresponding portion of the frequency range.

12. A first device comprising:
one or more processors configured to:
receive a request for determining a location of a device set, according to a frequency scan across a frequency range, the device set comprising a plurality of devices including the first device;
determine, according to one or more metrics, a state of each of the plurality of devices of the device set;
distribute, respective portions of the frequency range for scanning to the plurality of devices, according to the state of each device; and
determine the location of the device set, according to scan data received from the plurality of devices responsive to scanning the respective portions of the frequency range.

13. The first device of claim 12, wherein the portions of the frequency range are distributed such that the scan data from the devices of the device set are received by the first device at substantially the same time.

14. The first device of claim 12, wherein each device of the device set comprise a device which is held or worn by a single user, together with other devices of the device set.

15. The first device of claim 14, wherein the request comprises a first request, and wherein the one or more processors are configured to:
execute a scan manager and a location manager,
wherein the location manager is configured to:
receive a second request from an application of the first device, the second request corresponding to the first request;
transmit the first request to the scan manager responsive to the second request;
wherein the scan manager is configured to:
receive the scan data from each of the plurality of devices of the device set;
transmit, to the location manager, compiled scan data based on the scan data received from the plurality of devices.

16. The first device of claim 15, wherein the location manager is further configured to transmit the location of the device set to the application, where the location is determined according to the compiled scan data.

17. The first device of claim 12, wherein the scan data comprises an identifier of a remote device identified on a channel within the portion of the frequency spectrum and a signal strength of one or more signals detected from the remote device.

18. The first device of claim 17, wherein, to determine the location of the device set, the one or more processors are configured to:
transmit, to a server, compiled scan data comprising the identifiers of remote devices identified on the frequency spectrum and the corresponding signal strength of signals; and
receive, from the server, the location determined by the server according to the identifiers and the corresponding signal strength of the signals.

19. The first device of claim 12, wherein the one or more metrics comprise at least one of device capability information, scan duration, scan power, battery level, thermal level, or connection status information.

20. A non-transitory computer readable medium storing instructions that, when executed by one or more processors, cause the one or more processors to:
receive a request for determining a location of a device set, according to a frequency scan across a frequency range, the device set comprising a plurality of devices;
determine, according to one or more metrics, a state of each of the plurality of devices of the device set;
distribute, respective portions of the frequency range for scanning to the plurality of devices, according to the state of each device; and
determine the location of the device set, according to scan data received from the plurality of devices responsive to scanning the respective portions of the frequency range.
